(19) United States
(12) Patent Application Publication
(10) Pub. No.: US 2006/0253307 A1
(43) Pub. Date: Nov. 9, 2006

(54) Calculation of driver score based on vehicle operation

(76) Inventors: Gregory S. Warren, Atlanta, GA (US); Michael R. Greenlee, Atlanta, GA (US)

Correspondence Address: SMITH FROHWEIN TEMPEL GREENLEE BLAHA, LLC, P.O. BOX 88148, ATLANTA, GA, 30356, US

(21) Appl. No.: 11/408,420

(22) Filed: Apr. 21, 2006

Related U.S. Application Data
(63) Continuation-in-part of application No. 10/936,293, filed on Sep. 8, 2004.

(51) Int. Cl. G06Q 40/00

(52) U.S. Cl. 705/4

(57) ABSTRACT

The monitored use of a vehicle provides accurate and reliable data that can be used to determine the insurable risk of a vehicle operator. What is disclosed is a system and method for monitoring vehicle operation and using the collected data to calculate a driver score. The driver score can then be applied to ascertain the risk of insuring a particular driver, as well as being used as a tool for defining or adjusting the terms of an insurance policy for an insured driver. The collection of data such as the times the vehicle is operated, the locations the vehicle is operated and the speeds or other characteristics of how the vehicle is operated can all be used to calculate the driver score. By installing a vehicle monitor within a vehicle and extracting this or similar data, more accurate and profitable insurance policies can be developed.

### CROSS-REFERENCE TO RELATED APPLICATIONS

This application is a continuation in part of the United States Patent Application that was filed on Sep. 8, 2004 and assigned Ser. No. 10/936,293.

### BACKGROUND OF THE INVENTION

The present invention is directed towards data acquisition and processing of information related to various driver characteristics and, more particularly to collecting driver characteristic data and generating and driver score based on the collected driver characteristic data but that does not convey any information regarding the identity of the driver(s) and/or any detailed information about aspects that may be considered private (i.e., time and location of driver, vehicle identification number, etc.). The driver score can then be applied in the calculation of insurance premiums or risk analysis.

The insurance industry can be likened to an evening at a Las Vegas Black Jack table. The casino has picked the game and established the rules in such a manner that statistically over a period of time, the casino will win. Sure, some individual tourist will walk away with hundreds or thousands of dollars; however, compared to the number of visitors that leave tens, hundreds, thousands, and even tens or hundreds of thousands of dollars behind, these infrequent winners are negligible. This is quite evident upon staying at one of the casinos and viewing the elaborate decorations, the granite tiling in the bathrooms, the reduced pricing for food and of course, the open bar for active gamblers.

How does this relate to the insurance industry? Similar to the odds setters in Las Vegas, insurance companies have their own odds setters. The odds setters in the insurance industry include highly compensated and highly educated and trained actuarial scientists. The actuarial scientists acquire and analyze large amounts of varied data that is even remotely related to the calculation of insurance risks, and apply the results of this analysis in the calculation of insurance premiums. The task faced by the actuarial scientists is to derive insurance premiums for a large domain of individuals that in the long run, will result in the amount of premiums collected by the insurance company to be significantly larger than the amount of required insurance payouts.

Traditionally, the insurance industry generates individual policies that are more likely than not to be profitable to the insurance company. The various aspects of the policies include premiums, deductibles, exclusions, liability limitations, etc. The policies are developed based on various characteristics of the individual seeking the policy, the characteristics of the general populous, and the characteristics of categories of the general populous that may be applicable.

In the automotive insurance industry, the data related to the various characteristics of the individual are gathered through the use of standard forms, personal interviews, obtaining the applicant's public motor vehicle driving record maintained by governmental agencies or a combination of any of these methods. This data results in a classification of the applicant to a broad actuarial class for which insurance rates are assigned based upon the empirical experience of the insurer. Many factors are relevant to such classification in a particular actuarial class. These factors can include age, sex, marital status, vehicle type, vehicle color, location of residence, driving record including accidents, past insurance claims, at fault accidents, types of losses covered, liability levels desired, inclusion of uninsured motorists, inclusion of comprehensive coverage, inclusion of collision coverage, deductibles, etc. Some of these classifications can be further sub-divided into additional sub-classes, such as age ranges, and vehicle types (i.e., trucks, sports cars, sedans).

Similar to the goal of the Las Vegas Black Jack table attracting patrons, the insurance companies need to provide competitive pricing of their insurance policies. However, the insurance companies walk a fine line between offering competitive pricing while maintaining viable operating profits. Thus, insurance companies continually seek ways in which to provide competitive pricing without compromising their profit margins. Presently, some insurance companies address this need by providing discounts and surcharges for some types of use of the vehicle, equipment on the vehicle, and type of driver. For instance, the insurance company my add surcharges if the vehicle is being used for business. Likewise, the insurance company may provide discounts for vehicles that include airbags, antilock brakes, and theft deterrent devices, or if the driver has a good driving record or is a good student.

However, the insurance industry is faced with significant problems based on their current methodologies. For instance, the information obtained by the insurance company is time constrained. As and example, an insured party may live in a large city when obtaining the policy and subsequently move to the suburbs. Or the insured party may change jobs and consequently have a drastic change in the number of miles traveled during an insurance policy period. Unless the insured party notifies the insurance company regarding the address change, the expected mileage change or other such parameters, the insured party may end up paying a higher premium than would otherwise be available. Thus, the insurance company is vulnerable to churn based on lower premiums that may be offered by a competitor. In addition, the information collected by the insurance company may not be verifiable, and even existing public records may include limited or erroneous information. Thus, there is a need in the art for a more reliable and non-time sensitive mechanism for collection of information regarding the insured party.

Techniques have been suggested for addressing this problem in the art, such as the use of vehicle operating data recording systems. Such systems reside within a vehicle, measure various operating parameters, and report the information to a central recording system. In addition, the use of wireless or radio transmission of the data to the central recording system has also been suggested. However, there are no methods of applying this information in the insurance industry in an effort to improve the competitive nature of the insurance policy offerings. Thus, there is a need in the art for a method to identify pertinent vehicle operation information to be collected and to apply the collected information in a manner to generate a score that identifies the risks or insurability of a driver.

### BRIEF SUMMARY OF THE INVENTION

The present invention addresses these needs in the art, as well as other needs that are not herein identified, by providing a system and method for monitoring the use of a vehicle and calculating a driver score based on the monitored use. The driver score can then be applied in a variety of manners to achieve a variety of results, including but not limited to, determining or adjusting the terms of an insurance policy, such as changing the premium, the deductibles, the exclusions, the duration or the like. More specifically, a vehicle monitor is installed or coupled to a vehicle to be monitored. The vehicle monitor collects data from various sensors to identify vehicle operation data. Based at least in part on the vehicle operation data, a driver score is calculated and then the driver score is applied in setting or modifying the terms of the insurance policy either on a retroactive basis or on a forward looking basis.

In one embodiment of the invention, the vehicle monitor may be used to determine a driver score that serves as input for calculating the terms of a new insurance policy. In another embodiment, the vehicle monitor may be used to determine a driver score that serves as input for modifying the terms of an existing insurance policy. In another embodiment, the driver score can be used to determine whether a party qualifies for insurance.

The vehicle monitor may operate to collect a variety of information or operating parameters including the times during which the vehicle is operated, the geographic areas or sub-areas within which the vehicle is operated and the speeds at which the vehicle is operated. Other parameters could also be monitored by the vehicle monitor and all or only subsets of this information may be used in the determination of the driver score.

The determination of the driver score can be accomplished by the vehicle monitor, by a central system or by a combination of both. In addition to the driver score, other extrinsic data such as claim propensities, vehicle types, driver records and demographics may also be used in determining or adjusting the terms of the insurance policy. In addition, this extrinsic data may also be applied in the calculation of the driver score. The driver score, if collected and processed by an entity such as an insurance company, can be correlated with a specific driver, vehicle or insurance policy. However, the driver score when collected by a third party such as IVOX, in and of itself does not convey any information regarding the identity of the driver, vehicle, insurance policy or any other information that may be used to identify the driver, convey personal or confidential information about the driver, or information that could be used to derive the identity of the driver. Thus, the driver score provides an indicator that is based on monitored use of a vehicle and driving habits and/or characteristics. As such, the driver score, or a set of driver scores can be provided to others to serve as a basis for identifying driving trends (i.e., average speeds, delays at intersections, insurance risks on a zone basis, etc.). Another way to view this is that the driver score can operate as a privacy firewall, it conveys driving characteristics without providing or conveying data that could be considered as private. For instance, in once embodiment, the driver score can be provided in a manner that actually does not convey the identity of the driver. In another embodiment, the driver score may identify the related party but does not convey information such as when the driver drove, where he drove, how he drove, etc. Thus, the driver score can protect the granularity of the GPS/GIS data associated with a driver but still convey driving characteristics information and risks. The driver score includes a unique numeric identifier which correlates the data to a person and or vehicle. The driver score and its sub-element scores, such as an aggressive driving index, time of day index, speeding index, etc. are passed to the customer (i.e. insurance company, commercial trucking firm) without relaying any of the underlying granular GPS/GIS data.

### BRIEF DESCRIPTION OF THE SEVERAL VIEWS OF THE DRAWING

FIG. 1 is a block diagram of an environment suitable for various embodiments of the present invention.

FIG. 2 is a mapping diagram of a geographic region that is divided into sub-areas that illustrates the second parameter—where the vehicle is used.

FIG. 3 is a flow diagram illustrating the steps involved in an embodiment of the present invention.

### DETAILED DESCRIPTION OF THE INVENTION

The present invention is directed towards acquiring performance and usage data through various sensors and monitors within and without a vehicle, utilizing the performance and usage data to generate a driver score, and then utilizing the driver score in the calculations of insurance premiums or rating factors. In general, the present invention includes at least four distinct aspects. These aspects include: (1) the methods and devices utilized in the acquisition of performance and usage data; (2) the types of performance and usage data collected and the treatment of the ranges of the data values; (3) the method to calculate the drivers score based at least in part on the performance and usage data; and (4) the application of the driver score in the calculation of insurance premiums, rating factors, risk analysis, etc.

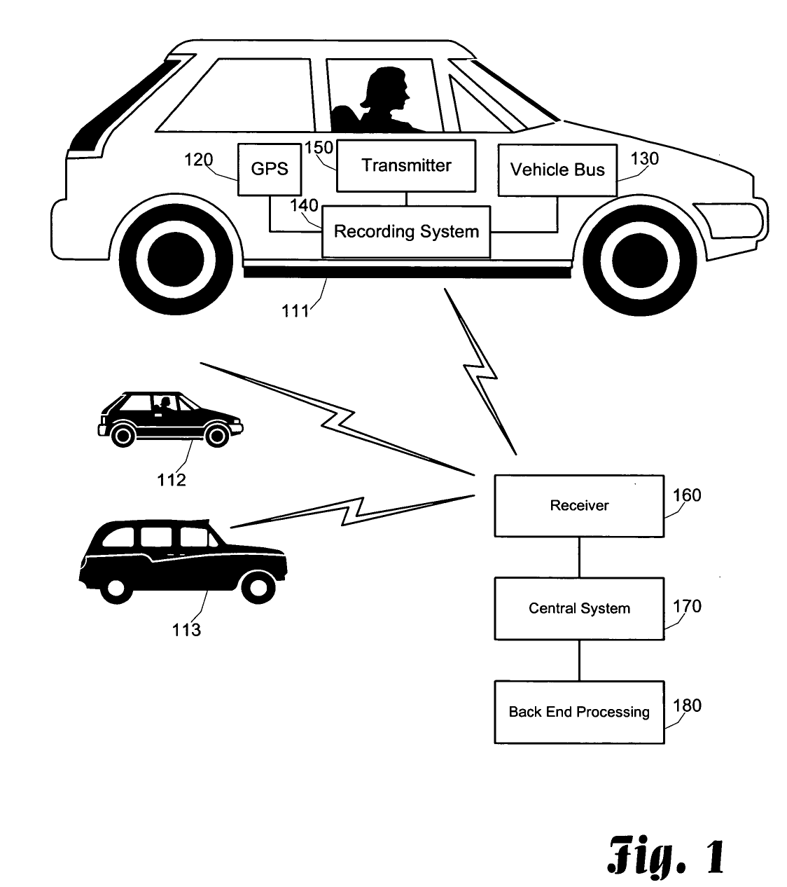

FIG. 1 is a block diagram of an environment suitable for various embodiments of the present invention. Three vehicles 111-113 are shown, for illustrative purposes, operating within the environment. Each of the vehicles is equipped with a data collection and recording system 140 but the details are only shown with respect to one of the vehicles 111. The data collection and recording system is shown as including two data collection interfaces: a GPS interface 120 and a vehicle bus interface 130. It should be understood that the present invention is not limited to these two interfaces nor are these two interfaces required for the present invention. Other interfaces are also anticipated such as weather information interfaces, clock interface, or other similar interfaces. The vehicle bus interface 130 can acquire information such as the speed of the vehicle, state of the windshield wipers, state of the lights (on, off, fog lights, brights, etc.), amount of pressure applied to the brakes, motion through the use of an accelerometer, time of day, temperature, vehicle maintenance, operation of equipment within the vehicle such as radios, cellular telephones, DVD players or the like, the volume at which audio equipment is operated, and the identity of the driver based on the entry of an identification number, seat settings, weight or the like, status of seat belts, number of passengers, etc. The GPS interface 120 can acquire information such as the location of the vehicle, time of day, direction of motion, speed of the vehicle, etc. A recording system 140 collects information from the data collection interfaces and either stores the information locally, transmits the information through transmitter 150, or applies processing to the information prior to either storing or transmitting the information. For instance, in an exemplary embodiment of the present invention, the system may only operate to collect time of day, location and speed information. In such an embodiment, the data recording system 140 operates to filter the data available from the data collection interfaces and only provide the necessary information to the central system. In an alternative embodiment, the data recording system 140 may operate to transmit all available information and a central system 170 operates to filter out the unnecessary information.

The data from the various vehicles 111-113 is received by a receiver 160 and then provided to a central system 170. The central system can perform processing on the received data, either alone or in conjunction with back end processing 180. The back end processing 180 may include input from actuarial scientist or other data collection and processing systems.

The data collected for the various vehicles may be transferred to the central system using a variety of different technologies and those skilled in the art will understand the benefits and limitations of each such technology. For instance, the invention may be embodied within an environment that uses wireless technology to periodically transmit collected data to the central system 170. The wireless technology may include pager technology or cellular technology conforming to any of a variety of past, existing or future technologies including FLEX, REFLEX, POCSAG, AMPS, NAMPS, TDMA, CDMA, GSM, GPRS or the like. Alternatively, the system may store the data and only transmit it when requested. In yet another embodiment, the data recording system 140 may store the data for later retrieval. Such later retrieval could be accomplished through a local wireless system, such as blue tooth, INFRARED, FM, AM, or I.E.E.E. 802.11 technology, or through a physical wired technology or even through the use of a memory card, storage media or print out.

Once the data is received by the central system 170, the data is used to generate a driver score. The driver score is based at least in part on the data collected by the vehicles and provided to the central system 170. However, additional data that is received independent from the data collection systems in the individual vehicles could also be used in calculating the driver score. This information may include the traditional information that has been collected by insurance companies for years as is listed in the background section, or may include other information such as satellite tracking of the vehicle, cellular signal tracking of the vehicle, weather information, mapping information, hazardous road condition information, or the like.

The driver score is basically a value that encompasses a variety of parameters. The driver score reflects a qualitative view of the driving characteristics for a particular vehicle or a combination of a vehicle and driver. Depending on the parameters that are used to calculate the driver score, the driver score can reflect various characteristics. In the preferred embodiment, the driver score operates to establish a risk level associated with insuring a particular driver. Other uses of the driver score may include, but are not limited to, verifying the accuracy of information provided to an insurance company, verifying compliance of a teenaged driver within guidelines established by his or her parents, verify compliance of teenaged drivers with local/regional laws such as curfew and number of passengers, etc.

Advantageously, an insurance company can offer a product embodying aspects of this invention to its customers and offer a discount based on the inclusion of the product. The customer can further agree to be bound by restrictions to gain other discounts. For instance, an insured party can agree to maintain within the speed limit to obtain a premium discount in exchange for allowing the insurance company the ability to actively monitor compliance. The present invention can also be utilized as a theft deterrent, similar to a LO-JACK type system in that the location of the vehicle can be monitored.

In the preferred embodiment, the driver score reflects an insurance risk and is used to either increase or decrease an insurance premium or otherwise modify the terms of an insurance policy.

Driver Score Example

The present invention can be illustrated through the use of an exemplary embodiment that bases the driver score on the following information: when the vehicle is in use, where the vehicle is used, and how the vehicle is used.

Table 1 illustrates a simple heuristic that can be applied to determine a weighted score reflecting the first parameter—when the vehicle is in use.

TABLE 1

| | Normal | Peak | | Weighted |
|---|---|---|---|---|
| Time of Day | Traffic | Traffic | Risk Traffic | Score |
| Risk Factor | 0.60 | 1.40 | 2.50 | |
| Driver A | 20% | 75% | 5% | 1.295 |
| Driver B | 80% | 20% | 0% | 0.760 |
| Driver C | 20% | 20% | 60% | 1.900 |
| | | | (capped at 50%) | 1.650 |

Various sensors or collection interfaces could be used to determine the time of day that a vehicle is operated such as through the GPS system, the vehicle bus, or through notifying the central system through a wireless interface. Regardless of the technique used, the time of day operational characteristics of a vehicle can be determined over a period of time and continually updated over time. The actual times that the vehicle is operated can be recorded by the recording system 140 and reported to the central system 170 or categories of times can be reported. Table 1 shows one technique to breakdown the operation of a vehicle within three time-categories, normal traffic, peak traffic and risk traffic. For instance peak traffic could include the times between 7:00-9:00 AM and 4:00-7:00 PM, risk traffic could include late night driving, such as between 11:00 PM to 4:00 AM and normal traffic would include the remainder. It will be appreciated that these categories are for illustrative purposes only and the present invention is equally applicable to other sets of categories. For instance, one or more of the following categories could be added to or substitute any of the already listed categories: weekend, particular day of the week, morning rush, evening rush, holiday travel, lunch time rush, garaged, parked, Sunday morning, Friday/Saturday evening, etc.

The second block in the left most column of Table 1 defines a risk factor for each of the listed time categories. The values listed in this table define a risk factor that is associated with driving during the identified time periods. This information can be derived using various techniques such as empirical data or information that is obtained from actuarial tables published by insurance companies. The risk factors can be based on a national average or could be regionally based as well.

Table 1 lists driving characteristics for three vehicles or drivers (Driver A, B and C). The driving characteristics provide a percentage of driving time that the vehicle is operated, or the driver operates a vehicle during the listed time categories.

Based on the risk factor and the driving characteristics, a weighted score, as shown in Table 2, is calculated by multiplying the percentage of time that a vehicle is operated in a particular category by the risk factor associated with that category and then summing the products for each of the categories. For the provided example, Driver A's weighted score is determined as follows:

TABLE 2

| | Claim | | % of | |
|---|---|---|---|---|
| Time-Category | Propensity | | Time | Products |
| Normal Traffic | 0.6 | * | 20% | 0.12 |
| Peak Traffic | 1.4 | * | 75% | 1.05 |
| Low Traffic | 2.5 | * | 5% | 0.125 |

| | |
|---|---|
| Weighted Score | 1.295 |

Driver B has more of a tendency to drive during normal traffic (80%) and thus, has a much lower weighted score of 0.76. Driver C has a tendency to drive late at night in the risk traffic category and thus has a weighted score of 1.9. Thus, Driver C has the highest weighted score. If it is desired not to penalize a driver that happens to be assigned to night shift work, one technique to alleviate an adverse affect based on Driver C's weighted score would be to apply a cap. For instance, if the late night percentage is capped at 50%, then the weighted score for Driver C drops to 1.65. This illustrates how the driver score can be flexible and fair by basing the data on more than just the actually measured data. For instance, if the driver score is being utilized by an insurance company to determine premium rates, the insurance company may decide not to penalize a night shift worker simply because his job forces him to travel within a higher risk time period. It will be appreciated that the driver score is simply a value and it does not contain any information regarding the particular identity of the driver and a reverse calculation procedure cannot be applied to the driver score to further gleam information regarding the driver. Thus, the driver score and its sub element scores can be tied to a particular driver, vehicle or insurance policy through the use of an indexed database, a file structure, a data structure or the like.

As such, one aspect of the present invention is the calculation of driver scores that can be provided to third parties to facilitate determination of driving characteristics on over a domain of drivers or regions. Because the privacy of the vehicle and/or driver is maintained by the entity calculating the driver scores, a block of driver scores can be provide to such third parties while maintaining the driver privacy. For instance, a block of driver scores calculated over a particular period of time can be used to identify insurance risks during that period of time without having to deal with privacy issues.

It should be understood that this example is provided for illustrative purposes only and that the present invention may use other techniques to calculate such a weighted score. For instance, rather than percentages of time, the actual number of hours averaged over a period of time, such as a day, week, month or quarter could be utilized. In addition, the application of risk factors to the various time categories can be adjusted based on a variety of factors, some of which may include, but are not necessarily required, are type of vehicle, driver's record, population of the area, etc.

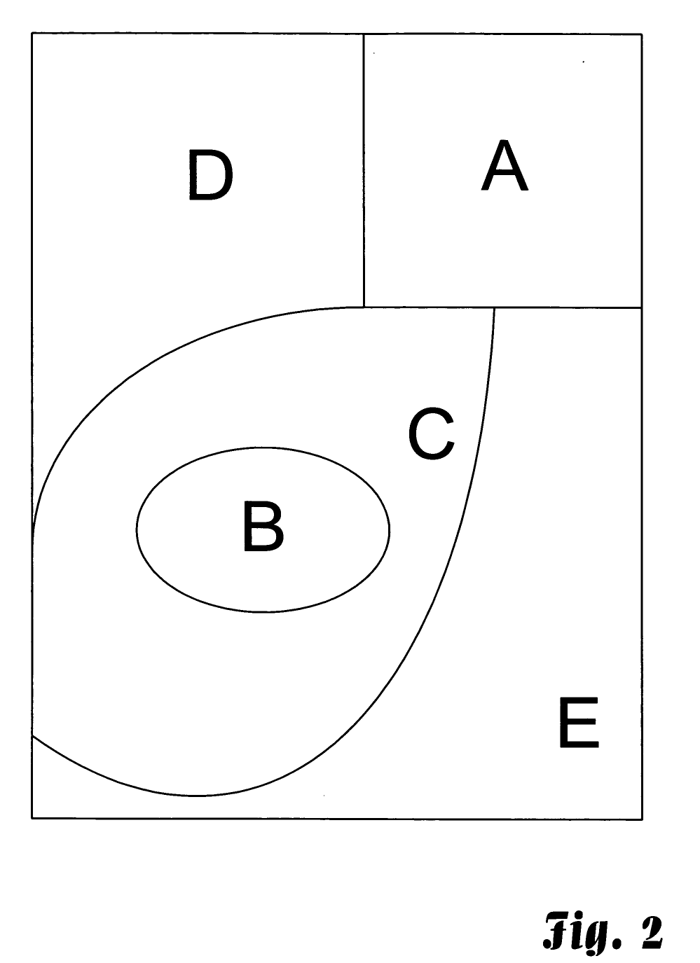

FIG. 2 is a mapping diagram of a geographic region that is divided into sub-areas that illustrates the second parameter—where the vehicle is used.

The region includes 5 sub-areas A-E. The sub-areas can be defined based on any of a variety of techniques including zip codes, area codes, counties, states, cellular cells, longitude and latitude, traffic density, population, road density, or any of a variety of other techniques of combinations of techniques. Regardless of the technique used to sub-divide a region, risk factor data for the region can be obtained and applied in the determination of a weighted score for this parameter. Table 3 illustrates a simple heuristic that can be applied to determine a weighted score reflecting the second parameter—where the vehicle is used.

TABLE 3

| | Rural | Suburb | Metro | Rural | Metro | Weighted |
|---|---|---|---|---|---|---|
| Area | Streets | Streets | Streets | H'way | H'way | Score |
| Risk Factor | 0.55 | 1.75 | 2.20 | 1.55 | 1.35 | |
| Driver A | 15% | 20% | 30% | 15% | 20% | 1.5950 |
| Driver B | 70% | 15% | 10% | 5% | 0% | 0.9450 |
| Driver C | 15% | 0% | 15% | 70% | 0% | 1.4975 |

The risk factor data for each region identifies a driving risk associated with that region. Thus, in the example provided, a high risk factor indicates that the area has a higher probability of resulting in an incident, such as a traffic accident, when a vehicle is operated in the area. Similar to the time of day calculations in Table 1, the risk factor values are multiplied by the percentage of time that the vehicle/driver is within that region or sub-area and then the products are summed to obtain the weighted score.

Again, the use of percentages is just an example and other criteria could also be applied such as accumulative hours over a period of time, average number of hours over a period of time, number of miles driven in the particular area, or the like.

In an alternative embodiment, the tables used to calculate a weighted score based on time of day and area can be combined into a multi-dimensional table. Thus, each of the sub-areas in the region could include a time of day table that includes different risk factors based on sub-area and time of day. For instance, the area surrounding a subway station may have a high risk factor during peak traffic but a very low risk factor during normal traffic. Thus, those skilled in the art will appreciate that various techniques can be applied to calculate the weighted scores and the examples provided in this description are simply to illustrate calculation of a value that rates driver characteristics. However, certain aspects of the selection of parameters and assignment of risk factors and techniques to calculate the score that are disclosed herein are also considered novel.

Table 4 illustrates a simple heuristic that can be applied to determine a weighted score reflecting the third parameter—how the vehicle is used. This example shows one alternative for calculating the driver score, or elements of the driver score by using an offset rather than a weighted score.

TABLE 4

| | | | Limited | Penalty |
|---|---|---|---|---|
| Speed | Highway | Streets | Access | Offset |
| Speed limit ± 5 mph | +0.015 | +0.025 | +0.02 | |
| Speed limit ± 15 mph | +0.05 | +0.10 | +0.08 | |
| Driver A | 10/4 | 4/2 | 4/1 | 0.81 |
| Driver B | 2/1 | 8/0 | 4/2 | 0.52 |
| Driver C | 5/0 | 5/0 | 4/0 | 0.28 |

The illustrated heuristic identifies offsets to be added to the weighted scores calculated in accordance with the first two parameters. The offset is based on ranges of miles per hour centered on the speed limit and the types of roadways being traveled. For instance, a set of offsets are provided for the highways, streets, and limited access roadways for speeds that are 5 mph above or below the posted speed limit and speeds that are 15 mph above or below the posted speed limit. This particular configuration is once again provided as an example only and the present invention is not limited to this particular configuration. For example, one set of offsets could also be used when the vehicle is a particular threshold below the speed limit and another set of offsets could be used when the vehicle is above the posted speed limit. In addition, the structure defined in Table 4 is set up as a penalty system. An award system could also be established to subtract offsets from the score based on conforming to the speed limit.

The values entered for Driver A, Driver B and Driver C illustrate an alternative method to the percentages used in the previous examples. In this example, the propensity of the driver on a scale of 0 to 10 is listed for the various conditions. This number could also represent a frequency over a period of time—for instance over a given period of time, Driver A will be over the speed limit by more than 5 mph 10 times and over the speed limit by more than 15 mph 4 times. For each occurrence, the offset is added for the particular driver. Thus, for Driver A, the total offset penalty of 0.81 is calculated as follows:
10*0.015+4*0.05+4*0.025+2*0.1+4*0.02+1*0.08=0.81

As previously mentioned, the examples that have been provided are for illustrative purposes only and other factors and weighting systems could also be incorporated into the present invention and the present invention is not limited to any particular arrangement. The main focus of the present invention is to provide a means for calculating a driver score that is based on various operational parameters. In the example provided, these parameters have included when the vehicle is in use, where the vehicle is used and how the vehicle is used.

Once the various parameters have been determined and the weighted scores and penalties calculated, then the driver score can be determined. For the illustrated example, the driver score is simply the sum of the “when” and “where” parameters plus the penalty or offset determined by the “how” parameters. Table 5 illustrates the calculation of the driver score for Driver A, Driver B and Driver C. Alternatively, the driver score could be calculated in different manners, such as multiplying the weighted score for the “when” with the weighted score for the “where” and than adding in the offsets. It will be appreciated that the particular technique employed, although novel in and of itself, in no way limits other aspects of the present invention.

TABLE 5

| | Driver A | Driver B | Driver C |
|---|---|---|---|
| Time of day (When) | 1.295 | 0.760 | 1.150 |
| Area (Where) | 1.5950 | 0.9450 | 1.4975 |
| Speed (How) | 0.81 | 0.52 | 0.28 |
| Driver Score | 3.7 | 2.225 | 2.9275 |

Thus, in the illustrated example, Driver A has a driver score of 3.7, Driver B has a driver score of 2.225 and Driver C has a driver scored of 2.9275. Based on the particular parameters and structure of the provided examples, in this situation Driver A is a higher risk driver than Driver B or Driver C. The driver score can then be used in a variety of manners. For instance, the driver score could be used as one of several parameters entered into the calculation of an automobile insurance premium or, as an offset or adjustment to an automobile insurance premium. The driver score could also be used for providing discounts or rate adjustments for life and/or health insurance. Other uses for the driver score may include, but are not limited to State tax credits, purchase price discounts or rebates for automobiles, discounts for extended warranties, discounts for vehicle registration, access to High Occupancy Vehicle (HOV) lanes or the like.

Table 6 illustrates one method of applying the driver score. In this example, the driver score is used to select a rating factor. The rating factor is a multiplier to the insurance premium derived using other available rating mechanisms.

TABLE 6

| Driver Score | Rating Factor |
|---|---|
| 0.0 to 0.9 | 0.85 |
| 1.0 to 1.75 | 0.90 |
| 1.76 to 2.49 | 0.95 |
| 2.50 to 3.19 | 1.00 |
| 3.20 to 3.59 | 1.05 |
| 3.60 to 3.99 | 1.10 |
| 4.0 to 4.29 | 1.15 |
| 4.30+ | 1.30 |

In accordance with Table 6 and the calculated driver scores, Driver A would have a rating factor of 1.10, Driver B would have a rating factor of 0.95 and Driver C would have a rating factor of 1.00. Thus, in this example, based on the rating factors, Driver A's premium would be increased by 10% based on his driver score, Driver B's premium would be reduced by 5% and Driver C's premium would not be adjusted.

Thus, the present invention has been described by way of example as a system that includes a vehicle based component and a central component. The vehicle based component collects usage data through one or more interfaces and then provides the usage data to the central system either by means of wireless transmission or other methods. The central system then calculates a driver score based at least in part on the usage data received, as well as claim propensity information. Finally, the driver score can be applied in adjusting the premium of an insurance policy or other terms and conditions of the policy.

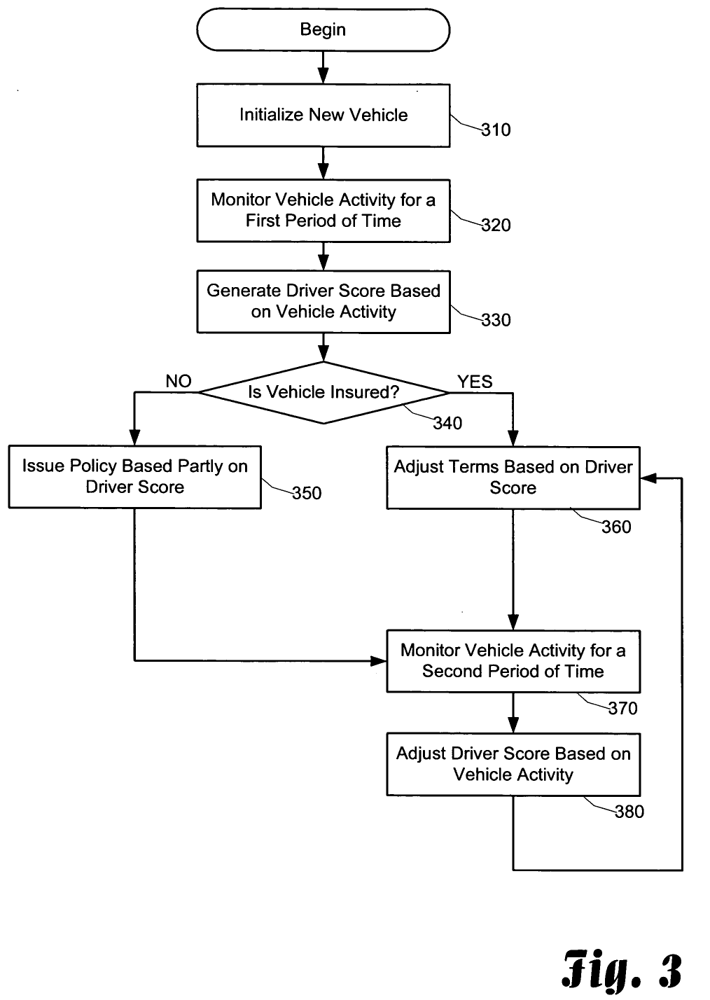

FIG. 3 is a flow diagram illustrating the steps involved in an embodiment of the present invention. The process begins at step 310 where a new vehicle is selected for driver score based insurance. At step 310 the new vehicle is initialized. This process can include a variety of tasks, such as but not limited to nor requiring, installation of the monitoring and recording system into the vehicle, provisioning the system including provisioning of any wireless communication systems, entry of user data into the central system and verification of operation. These tasks can include gathering initial information about the driver, the vehicle, the topographical area in which the vehicle is operated, the identification of what drivers will be utilizing the vehicle, matching the identification of the monitoring and recording system with the drivers, etc.

Once the system is initialized, the monitoring and recording system begins to monitor the vehicle activity for a first period of time 320. The data collected can be provided to the central system either on-line in real-time, periodically over a wireless interface, or through physically docking the vehicle with the central system either locally or remotely. The first period of time can vary depending on the particular embodiment but generally is sufficiently long to obtain data that is an accurate portrayal of the vehicle activity. Logically an entire year would seem like a valid period when calculating a driver score for insurance premium purposes but realistically, this would not be practical. Thus, a shorter period of time that encompasses enough variants in the individuals schedule should suffice. For instance, a two to four week period of time may be sufficient if during that period of time, no extreme conditions occur, such as the driver going on vacation, the driver taking an extended road trip or the vehicle being in the shop.

Once the first period of time has been satisfied, the system can operate to generate the driver score 330. As previously described, the driver score may include a variety of parameters with various weights applied to the parameters. Several examples have been previously provided, each of which may contain novel aspects of the invention, yet do not operate to limit the generality of the invention to utilize various other parameters, combinations of parameters and the application of various weighting factors.

Once the driver score is determined, if the vehicle or user is currently uninsured 340, the processing continues at step 350 where the driver score is applied in the selection and definition of an insurance policy. On the other hand, if the vehicle or user is already insured, processing continues at step 360 where the terms of the insurance policy can be adjusted. In steps 350 and 360, the typical application of the driver score is in the adjustment of the insurance premium, however, other adjustments or term settings could also be made, such as but not limited to, changing deductibles, changing exclusions, changing the duration of the policy, etc.

After the completion of steps 350 or 360, processing continues at step 370 where the vehicle activity continues to be monitored. At step 370, the monitoring process continues for a second duration of time. The second duration of time can be as insignificant as seconds or fractions of seconds or, could be substantial such as days, weeks, etc. Preferably, the second period of time is less in duration than the first period of time but this is not a requirement.

Upon completion of the second period of time, the driver score is then adjusted at step 380. The adjusted driver score is then reapplied in step 360 for adjusting the terms of the insurance policy. Thus, the driver score and the terms of the insurance policy can be continually updated as the system collects further information about the vehicle activity.

In an alternate embodiment, an insurance policy can simply be issued to an insured party at premiums and terms calculated in the normal fashion. Subsequent premiums and terms can then be adjusted over time by employing the monitoring and driver score calculation aspects of the present invention.

The present invention has been described using detailed descriptions of embodiments thereof that are provided by way of example and are not intended to limit the scope of the invention. The present invention can be implemented as a process that runs within a variety of system environments or as an entire system including various components. The described embodiments comprise different features, not all of which are required in all embodiments of the invention. Some embodiments of the present invention utilize only some of the features, aspects or possible combinations of the features or aspects. Variations of embodiments of the present invention that are described and embodiments of the present invention comprising different combinations of features noted in the described embodiments will occur to persons of the art.

What is claimed is:

1. A method of quantifying vehicle activity, the method comprising the steps of:
monitoring particular parameters of the activity of a vehicle for a first period of time;
calculating a driver score based at least in part on the particular parameters of the vehicle activity during the first period of time, the driver score being independent from the identity of vehicle; and
maintaining a database to correlate the driver score with the vehicle identity.

2. The method of claim 1, further comprising the step of applying the driver score to adjust the terms of an insurance policy for the vehicle.

3. The method of claim 2, wherein the terms of the insurance policy that are adjusted include the deductibles.

4. The method of claim 2, wherein the terms of the insurance policy that are adjusted include the premiums.

5. The method of claim 1, wherein the step of calculating a driver score further comprises the steps of:
identifying time of day classes in which the vehicle can be utilized;
determining the amount of driving time that the vehicle is used in each of the time of day classes;
calculating a time of day weighted value based at least in part on the amount of driving time that the vehicle is used in each of the time of day classes; and
applying the time of day weighted value in the calculation of the driver score.

6. The method of claim 5, wherein the step of calculating a time of day weighted value further comprises calculating a time of day weighted value based at least in part on risk tendencies for the time of day classes.

7. The method of claim 5, wherein the step of calculating a driver score further comprises the steps of:
identifying geographical sub-areas in which the vehicle can be utilized;
determining the amount of driving time that the vehicle is used in each of the geographical sub-areas;
calculating an area weighted value based on the amount of driving time that the vehicle is used in each of the geographical sub-areas; and
applying the area weighted value in the calculation of the driver score.

8. The method of claim 7, wherein the step of calculating an area weighted value further comprises calculating an area weighted value based at least in part on risk tendencies for the geographical sub areas.

9. The method of claim 7, wherein the step of calculating a driver score further comprises the steps of:
identifying speed classes in which the vehicle can be utilized;
determining the frequency at which the vehicle is used in each of the speed classes;
calculating a speed weighted value based at least in part on the frequency at which the vehicle is used in each of the speed classes; and
applying the speed weighted value in the calculation of the driver score.

10. The method of claim 1, wherein the step of calculating a driver score further comprises the steps of:
identifying geographical sub-areas in which the vehicle can be utilized;
determining the amount of driving time that the vehicle is used in each of the geographical sub-areas;
calculating an area weighted value based on the amount of driving time that the vehicle is used in each of the geographical sub-areas; and
applying the area weighted value in the calculation of the driver score.

11. The method of claim 1, wherein the step of calculating a driver score further comprises the steps of:
identifying speed classes in which the vehicle can be utilized;
determining the frequency at which the vehicle is used in each of the speed classes;
calculating a speed weighted value based at least in part on the frequency at which the vehicle is used in each of the speed classes; and
applying the offset value in the calculation of the driver score.

12. The method of claim 1, further comprising the steps of:
monitoring the activity of the vehicle for a second period of time; and
adjusting the driver score based at least in part on the vehicle activity during the second period of time.

13. A method of generating a rating factor for a vehicle that can be disseminated without revealing the identity of the vehicle but still conveying valuable information, the method comprising the steps of:
installing a vehicle monitor within a vehicle;
monitoring the activity of the vehicle for a first period of time;
calculating a driver score based at least in part on the vehicle activity during the first period of time;
providing the driver score to a third party while maintaining the identity of the vehicle as private information;
monitoring the activity of the vehicle for a subsequent period of time; and
adjusting the driver score based at least in part on the vehicle activity during the subsequent period of time; and
providing the adjusted driver score to the third party while maintaining the identity of the vehicle as private information.

14. The method of claim 13, wherein vehicle monitor includes a wireless interface and the step of calculating a driver score further comprises the steps of:
wirelessly transmitting data obtained from the monitoring step to a central system; and
the central system calculating the driver score based at least in part on the transmitted data.

15. The method of claim 14, wherein the step of calculating a driver score further comprises the steps of:
identifying time of day classes in which the vehicle can be utilized;
determining the amount of driving time that the vehicle is used in each of the time of day classes;
calculating a time of day weighted value based on the amount of driving time that the vehicle is used in each of the time of day classes and claim propensities for the time of day classes;
applying the time of day weighted value in the calculation of the driver score;
identifying geographical sub-areas in which the vehicle can be utilized;
determining the amount of driving time that the vehicle is used in each of the geographical sub-areas;
calculating an area weighted value based on the amount of driving time that the vehicle is used in each of the geographical sub-areas and claim propensities for the geographical sub-areas;
applying the area weighted value in the calculation of the driver score;
identifying speed classes in which the vehicle can be utilized;
determining the frequency at which the vehicle is used in each of the speed classes;
calculating an offset value based on the frequency at which the vehicle is used in each of the speed classes; and
applying the offset value in the calculation of the driver score.

16. The method of claim 13, wherein the step of monitoring the vehicle during the first period of time further comprises the steps of:
identifying times during the first period of time at which the vehicle was operated;
identifying geographical sub-areas in which the vehicle was operated during the first time period; and
identifying the speeds at which the vehicle was operated during the first period of time.

17. The method of claim 16, wherein the step of calculating a driver score further comprises the steps of:
applying the identified times, geographical sub-areas and speeds in the calculation of the driver score.

18. A system for calculating a driver score and providing the driver score to a third party without revealing the identity of the driver and/or vehicle, the system comprising:
a recording system that is installable within a vehicle;
a GPS interface that is coupled to the recording system;
a vehicle bus interface that is couple to the recording system;
a transmitter coupled to the recording system for transmitting vehicle operation data obtained by the recording system through the GPS interface and the vehicle bus interface;
a receiver that is communicatively coupled to the transmitter for receiving the vehicle operation data; and
a central system that is coupled to the receiver and operable to:
calculate a driver score based at least in part on the vehicle operation data; and
provide the driver score to a third party.

19. The system of claim 18, wherein the transmitter and the receiver are communicatively coupled over a wireless interface.

20. The system of claim 18, wherein the wireless interface is a cellular interface.

21. The system of claim 18, wherein the wireless interface is a pager interface.

22. The system of claim 18, wherein the vehicle operation data comprises:
times at which the vehicle is operated;
locations in which the vehicle is operated; and
speeds at which the vehicle is operated;

23. The system of claim 22, further comprising a back end processor that is coupled to the central system and is operable to provide the central system with claim propensity data related to time, locations and vehicle speeds.
